(19) United States
(12) Patent Application Publication
(10) Pub. No.: US 2015/0030208 A1
(43) Pub. Date: Jan. 29, 2015

(54) SYSTEM AND A METHOD FOR MOTION ESTIMATION BASED ON A SERIES OF 2D IMAGES

(71) Applicant: IRIDA LABS S.A., Patras (GR)

(72) Inventor: Nikos Fragoulis, Patras (GR)

(73) Assignee: IRIDA LABS S.A., Patras (GR)

(21) Appl. No.: 13/952,894

(22) Filed: Jul. 29, 2013

(51) Int. Cl. G06T 7/20

(52) U.S. Cl. CPC G06T 7/2033; G06T 2207/10016
USPC 382/107

(57) ABSTRACT

By collecting, analyzing and processing a series of images captured by a camera one can estimate the motion that a device containing the camera has experienced. Exemplary techniques disclosed herein at least enable device motion estimation based on any selection of images from a camera related to the device.

### BACKGROUND

1. Field

An exemplary aspect of this invention relates to the field of motion estimation. More specifically the invention relates to a method and a system capable of extracting motion information from a device equipped with a camera of any kind.

2. Background

There are many known devices that are able to measure angular velocity—typically characterized as gyroscopes. These devices are made of electrical and mechanical parts and sometimes are large-scale integrated in order to form a chip using a technology known as MEMS (Microelectromechanical Systems).

In recent years, MEMS gyroscopes have been increasingly used in high-end mobile devices in order to enhance their Human Computer Interface (HCl) capabilities. For example, the screen rotates when one rotates a mobile phone because of measurements taken by a gyro. As another example, many games in handhelds use a gyro to control the motion within a game—the gyro detects tilting, lifting or turning and causes motion that relates to that activity (e.g. tilt right causes a “car” in a video game to turn right, etc.)

While gyros are primarily used for HCl features, gyros can also be used for other functionality enhancements such as video stabilization, where motion information is used in order to adjust the video-frame sequence to show a more stable scene.

However, the functionality enhancements that gyros provide require dedicated hardware (usually in the form of silicon devices) and thus increase a device's bill of materials (BOM) and thus the cost and the size of the mobile device.

The present invention seeks to provide a low-cost alternative to the use of MEMS gyros, without the need for dedicated hardware such as a gyro. The invention utilizes components that already exist on a device, such as the camera sensor that exists on many modern mobile devices, even low-cost ones. By capturing and appropriately analyzing camera data precise, fast and reliable motion estimation is performed without the need for dedicated hardware.

The present invention seeks to provide robust motion estimation while at the same time requiring low computational complexity, low processing power and low power consumption.

### SUMMARY

An exemplary aspect of the invention refers to a system capable of extracting motion information from a mobile device equipped with a camera sensor of any kind, using data from this sensor. This is achieved by using an onboard processor to analyze the video stream from the onboard camera.

An exemplary aspect of the invention includes a series of stages of analysis of the camera data in order to achieve robust performance.

For robust estimation of large camera movements, a coarse-fine subsystem is included to be able to efficiently detect large movements and at the same time maintain the necessary precision of small movements.

An exemplary aspect of the invention also includes an outlier rejection subsystem, which enhances the precision of the motion estimation by detecting and rejecting false estimations.

An exemplary aspect of the invention utilizes a global motion estimation subsystem, which is based on a Least Mean Square approach. This subsystem in conjunction with the outlier rejection subsystem enables precise estimation of motion.

By collecting, analyzing and processing a series of images captured by a camera, one can estimate the motion that a device containing the camera has experienced. The methods of this invention enable device motion estimation based on any selection of images from a camera related to the device. The processing of pixels and collections of pixels from the images is performed by a processing unit on the device, such as a programmable computational device capable of processing digital signals, a dedicated silicon engine that can process digital signals or a combination of these.

### BRIEF DESCRIPTION OF THE DRAWINGS

The embodiments of the invention will be described in detail, with reference to the following figures, wherein:

FIG A shows an exemplary 2-D map of motion vectors indicating how the pixels in a video frame move between two consequent video frames in a video sequence;

FIG. 1 illustrates an exemplary system that shows how optical flow information is extracted from an image frame sequence;

FIG. 2 illustrates an exemplary Motion Detection Device through which the system extracts and manages the optical flow in order to calculate the motion information;

FIG. 3 illustrates an exemplary distribution of points of interest within an image frame in an image frame sequence;

FIG. 4 illustrates an exemplary procedure that shows how a motion vector is calculated in the Local Motion Estimation unit using a block search algorithm;

FIG. 5 illustrates an exemplary flow chart indicating the computational steps needed to compute the optical flow between two consequent video frames in a video sequence;

FIG. 6 illustrates an exemplary flow chart indicating the computational steps needed to detect an outlier within a motion vector set;

FIG. 7 illustrates through an example the effect that global motion parameters have on an image frame in an image frame sequence;

FIG. 8 illustrates through an example the effect that image sub-sampling has on the search radius of the block search algorithm used by Local Motion Estimation unit;

FIG. 9 illustrates an exemplary embodiment of operation of the unit; and

FIG. 10 illustrates the optical flow generated by some basic camera motions.

### DETAILED DESCRIPTION

In the event that a camera is embedded on a device, camera motion and device motion are directly related to one another. With this in mind, in the current description the estimation of either device or camera parameters are used interchangeably.

In an exemplary approach, camera motion parameters are estimated through the analysis of Optical Flow.

Optical flow is a 2-D map of motion vectors indicating how the pixels in a video frame move between two consequent video frames in a video sequence. The optical flow can be measured in all the pixels of an image or to some of them.

In FIG A, a pixel G is moving between two consequent video frames from position (x1,y1) to a position (x2,y2) (A4 in FIG A). The combination of the displacement along the x-axis ΔX=x2−x1 and along the y-axis, Δγ=y2−y1, gives the motion vector Z of the pixel G. However, the measurement of the motion of a pixel is not practically feasible, since it does not have any unique characteristic that differentiate it from the neighboring pixels. So in practice the motion of blocks of pixels is measured. FIG A also shows an example of an optical flow map. Ideally all the motion vectors of an image are moving in the same direction (A1 in FIG A), and in this case the global motion of the frame is obtained relatively easy. However in practice the optical flow map will not have this kind of uniformity (A2 in FIG A). This may be due to errors that slip into the block motion estimation process, or due to the existence of moving objects that move totally differently than the background or due to other factors. The result is a collection of motion vectors that are considered as “outliers” (A3 in FIG A).

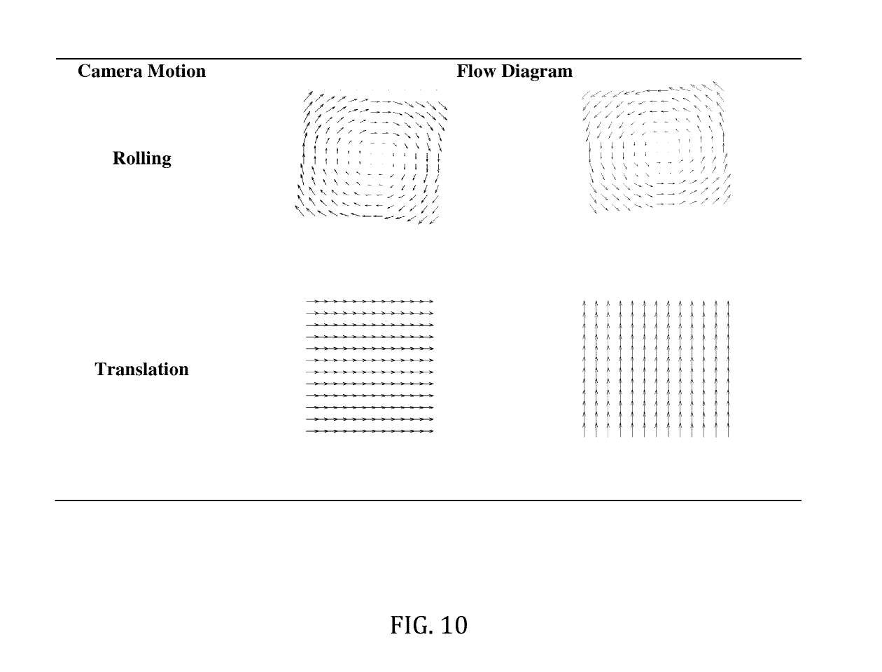

As additional examples, the optical flow generated by some basic camera motions is shown in FIG. 10.

Optical flow can be determined by measuring the motion of several pixels in a frame between two consequent frames in time. The line connecting the starting and the end point of the route that a certain pixel covers in time between the two frames creates a motion vector with a certain magnitude and orientation. Since the associated distance is covered within a strictly defined time interval (e.g. 1/30 of a second), each vector corresponds to a certain velocity vector.

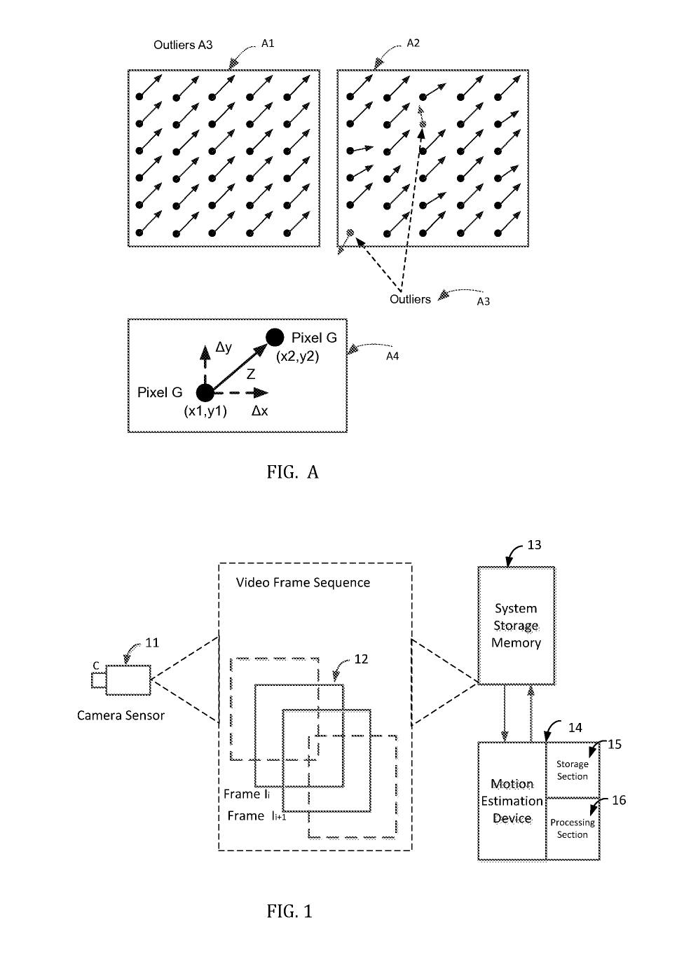

In accordance with an exemplary embodiment of the present invention, optical flow information is extracted from an image frame sequence by using an exemplary system like the one shown in FIG. 1. This system uses a camera sensor (11 in FIG. 1) which captures the video frames (12 in FIG. 1), stores the two most recent frames in a memory (13 in FIG. 1) and then processes them with a motion detection device (14 in FIG. 1), comprised by a storage section (15 in FIG. 1) and a processing section (16 in FIG. 1) in order to extract motion information.

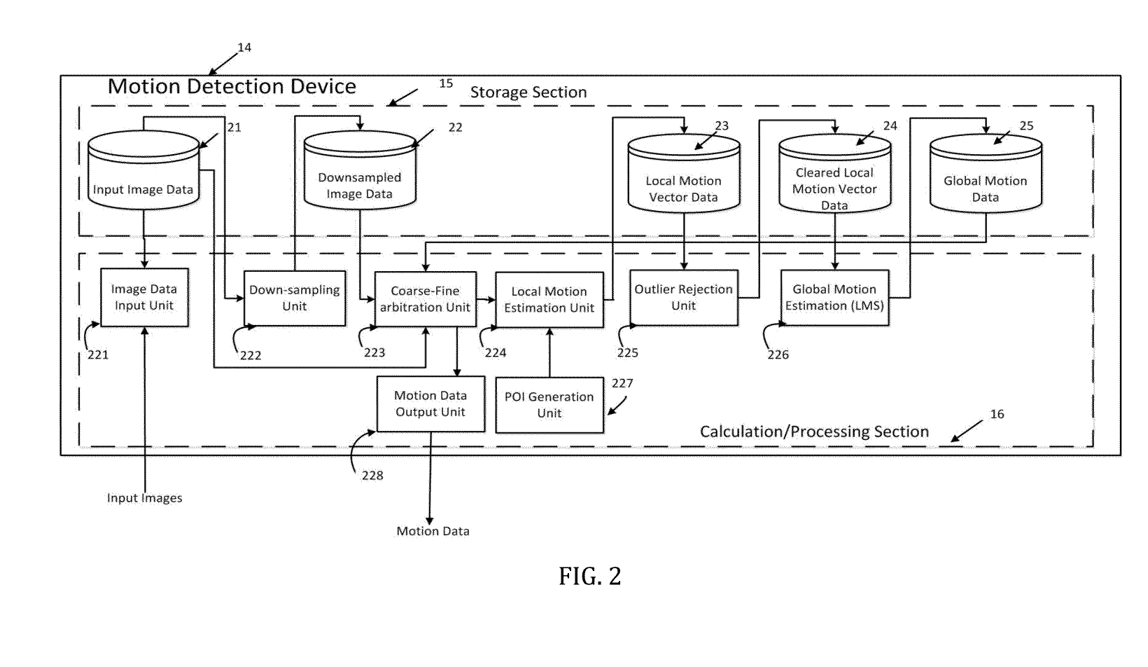

An exemplary Motion Detection Device through which the system extracts and manages the optical flow in order to calculate the motion information is shown in FIG. 2.

This system functions as follows: First two consecutive frames Iᵢ and Iᵢ₊₁, (12 in FIG. 1) are input into the Image Data Input Unit (221 in FIG. 2) from the Storage Memory (13 in FIG. 1) and are temporarily stored into the Input Image Data memory (21 in FIG. 2). The data are then fed into the Down-sampling Unit (222 in FIG. 2), which down-samples and stores them to the down-sampled image data memory (22 in FIG. 2). Data from the down-sampled image data memory and from the image data memory are then fed into the Coarse-Fine Arbitration unit (223 in FIG. 2). This unit then feeds down-sampled data into the Local Motion Estimation Unit (224 in FIG. 2), if coarse estimation is carried-out, or original data, if fine estimation is carried out.

The following procedure is then repeated twice, once for coarse estimation and once for fine estimation. The Local Motion Estimation Unit takes also input from the points-of-interest (POI) Generation Unit (227 in FIG. 2), in order to obtain the motion vectors (optical flow) between two consequent frames. The motion vectors are then stored in the Local Motion Vector Data memory (23 in FIG. 2). The motion vector data is then fed into the Outlier Rejection Unit (225 in FIG. 2), which controls their consistency and removes any outliers. The outlier-free or “cleared” motion vector data and the corresponding POIs are stored in the Cleared Local Motion Vector Data memory (24 in FIG. 2) and then are fed into the Global Motion Estimation Unit (226 in FIG. 2). This unit calculates the global motion and outputs the global motion data to the Global Motion Data storage memory (25 in FIG. 2). Finally the data are fed into the Coarse-Fine Arbitration unit (223 in FIG. 2).

After finishing the coarse and the fine estimation, the data from the Coarse-Fine Arbitration unit are fed to the Motion Data Output Unit (228 in FIG. 2) and from there, to the system output.

In the following sections, the above-referred units are explained in detail.

POI Generation Unit (227 in FIG. 2).

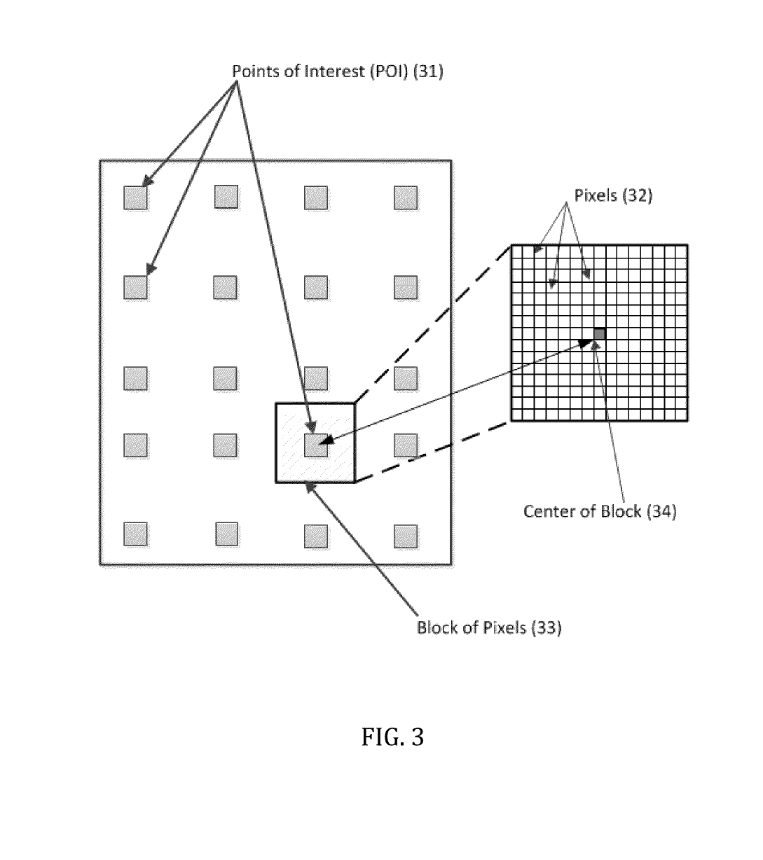

This subsystem calculates the motion of collections of subsets of pixels (32 in FIG. 3) (called “pixel blocks”) from consecutive video frames. The pixel blocks (33 in FIG. 3) are located around a set of Points Of Interest (POIs): PS={P₁ (x, y), P₂ (x, y), . . . , P_{NP} (x, y)} (31 in FIG. 3) in a way that each POI is at the center of the Pixel Block (34 in FIG. 3) or related in a predetermined way to the subset of pixels. For illustration purposes, we assume that the POIs are at the center of the pixel block in the sequel.

These POIs can be selected in many ways. One way is to use characteristic metrics in order to select points that will robustly determine the motion from frame to frame. Such metrics exploit features such as corners, edges, points, etc.—characteristics that are distinct and will track easily between frames. The use of such POIs often produces robust motion estimation results in general. However, the determination of such features may require a significant amount of computational complexity because this determination depends upon the contents of the frame. This in turn expends power and energy and therefore is inefficient for applications such as mobile devices where the power budget is typically limited.

An alternative way is to fix a particular and predetermined set of POIs as reference points having specific, predetermined x, y coordinates on a Cartesian x-y plane defined within an image frame. By way of example, 64 POIs can be selected as a grid of equidistant points across an image as 8 rows of 8 POIs each. This makes the choice of the POIs straightforward and independent of the content of the frame. Using this approach, the excess computational power of determining where the POIs should be located is avoided. However the quality of the optical flow measurements may be compromised since the POIs chosen in this fashion may not be ideal for determining motion between frames. Because of this, signal-processing solutions must be employed to produce favorable results from the associated data. Therefore one system includes an Outlier Rejection unit (225 in FIG. 2), and in addition a special statistical manipulation of the motion vectors is employed in the Global Motion Estimation unit (226 in FIG. 2).

It is also feasible to use a combination of POIs that are independent of the content of the frame (such as a rectangular or other grid) and POIs that are related to metrics determined by the content of the image that identify, for example, edges, points, corners, etc. This combined choice of POIs can take advantage of the “content-independent” approach to selecting POIs while also leveraging the availability of POIs related to the content when those are available. In some systems, such content-related POIs (that identify corners, edge, lines etc. within a specific image) may be available anyway and not require additional computational resources. When possible, the use of such POIs can be utilized to improve the robustness and performance of the methods described in this invention.

Local Motion Estimation Unit (224 in FIG. 2)

The local motion Estimation (LME) unit aims to estimate motion of specific pixel-blocks in a video sequence using a block-search algorithm. The block search algorithm defines a block of pixels around a POI and then aims to determine how this block of pixels moves from frame Iᵢ to frame Iᵢ₊₁. This can be achieved by forming a basis block of pixels in frame Iᵢ and then search all the consecutive, geometrically identical to the basis, blocks of pixels in frame Iᵢ₊₁ estimating their similarity with the basis block. Due to the limited computational capacity of real-world computers, the radius of the block-search is limited to a value of search_radius. Once the best match has been defined, its distance to the basis block forms a two-dimensional motion vector MVₖ for this block. The set MV={MV₁, MV₂, . . . , MV_{NP}} of the motion vectors calculated for all the POIs, are the optical flow which will later be analyzed by the Global Motion Estimation Unit (35 in FIG. 2) in order to estimate the motion of the camera sensor.

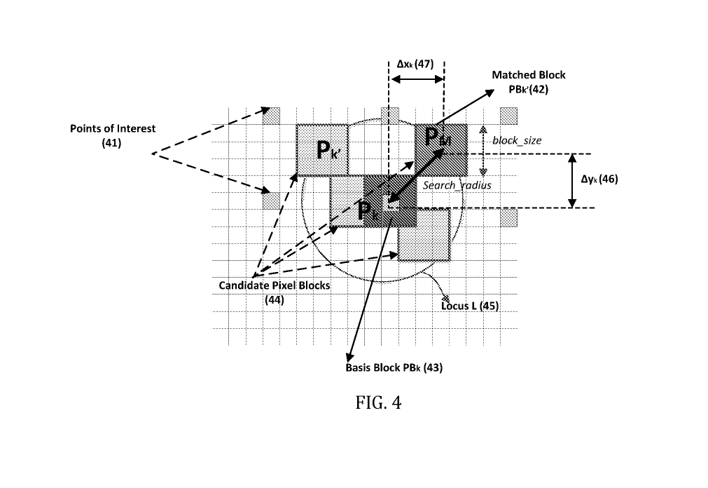

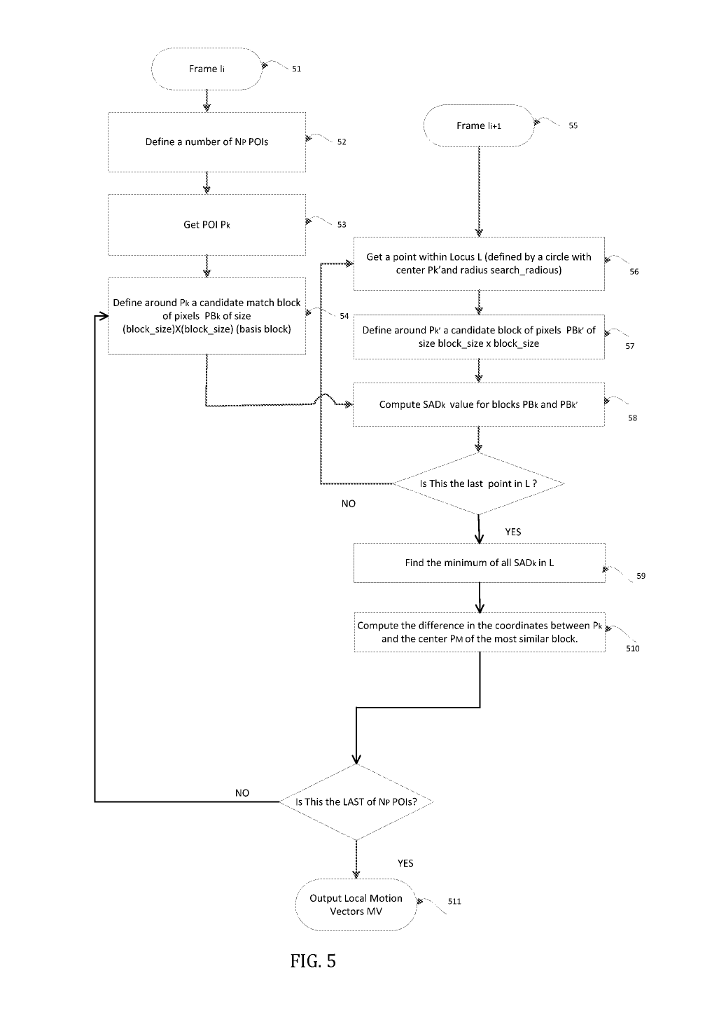

More specifically, the procedure of block-search algorithm is the following: As a first step, as described above, a set of POIs are defined in the POI generation unit (32 in FIG. 2) in the Cartesian x-y plane for N_{P} points (41 In FIG. 4, 52 in FIG. 5). Note that it is possible that some of the POIs may be related to the content, such as edges, corners, etc, of the image. Then the following procedure take place for each POI in the set: First in frame Iᵢ (51 in FIG. 5), a point of interest Pₖ (x, y) from now-on referred as Pₖ) is selected (53 in FIG. 5), and a pixel block PBₖ of size (block_size)×(block_size) is formed around it (43 in FIG. 4, 54 in FIG. 5), in a way that the POI Pₖ to be the center of block PBₖ. This block will serve as a basis block. In the next frame, Iᵢ₊₁ (55 in FIG. 5), the geometric locus L is defined as the area within a circle with radius search_radius and center Pₖ (45 in FIG. 4). It is also possible that the locus be identified as a shape or relation between pixels other than a circle. In the detailed description, it is assumed that the locus is a circle. Then all pixel blocks (44 in FIG. 4) with their center pixels lying within L are candidates to be matches of the basis pixel block PBₖ and therefore their similarity with it will be checked with the help of a similarity measure calculation.

More analytically, the procedure of checking the similarity between blocks of pixels is the following: First a point Pₖ, is selected within locus L (56 in FIG. 5), and a pixel block PBₖ, of size (block_size)×(block_size) is formed around it (57 in FIG. 5).

The next step is to check the similarity between the basis and the candidate block of pixels (58 in FIG. 5). One preferred method for checking the similarity between blocks of pixels is based on the computation of a similarity measure known as Sum of Absolute Differences (SAD). According to the definition of this measure the similarity between two blocks of pixels PBₖ and PBₖ, is given by the following formula:

SADₖ=Σᵢ₌₁^{block}^{_{—}}^{size}Σⱼ₌₁^{block}^{_{—}}^{size}|PBₖ(i,j)−PBₖ,(i,j)| (1)

This measure will produce lower values for pixel blocks that are more similar. However, any method of measuring the similarity between the blocks can be utilized.

The block featuring the maximum similarity (and thus the lowest SAD value) is identified as the matched block (42 in FIG. 4, 59 in FIG. 5), and its center P_{M} (x_{M}, y_{M}) is considered to be the new position of the basis pixel block. This produces a motion vector MVₖ=(Δxₖ, Δyₖ)=(x_{M}−x, y_{M-y}) (46,47 in FIG. 4, 510 in FIG. 5), for POI Pₖ.

By repeating the procedure described above for each POI, a set of motion vectors MV={MV₁, MV₂, . . . , MV_{NP}}={(Δx₁, Δy₁), (Δx₂,Δy₂), . . . , (Δx_{NP}, Δy_{NP})} is produced which is the output of the LME Unit (511 in FIG. 5) and which corresponds to the optical flow between frames Tᵢ and Iᵢ₊₁.

Outlier Rejection Unit (225 in FIG. 2)

The Local Motion Estimation (LME) Unit produces a set MV of motion vectors (cardinality N_{P}), which must then be analyzed and processed in order to obtain the global frame motion corresponding to the device motion—which is the motion of the device on which the camera sensor is located.

However, in realistic environments there are usually errors in the estimation of the optical flow from the LME. This is due to the presence of image noise of several types, due to inaccuracies caused by the way that POIs are selected as well as due to the method implemented in the local motion estimation unit. In addition the motion of the camera is not the only source of motion within field of view, because usually there are moving objects since cameras are often used to catch an action scene. In this case there is a strong possibility that the motion vectors, even if there are accurate, will not describe only the motion of the camera but also the motion of some moving object. It is also possible, that certain POIs are known to be more likely to produce a more accurate motion vector. For example, if a POI is known to be related to an image characteristic such as a corner, edge, etc, the Local Motion Estimation from that POI may be more accurate than others that are not related to any content in the image. These can be weighted more significantly in the calculations of central tendency and outliers described below. Because of this, there are cases where the estimation error is large and this is the case for the presence of an “outlier”. In statistics, an outlier is an observation that is numerically distant from the rest of the data. Therefore outliers are very undesirable since even when small in number, they confuse the global motion estimation sub-system and produce false estimates of global motion.

In order to address the outlier problem, an outlier rejection unit has been included in the invention. The unit implements a technique named n-sigma rejection. According to this technique, the central tendency μ of the calculated motion vectors form a set MV with cardinality N_{P}, are first computed. Then a variation or dispersion measure sigma is computed which indicates how much variation or dispersion exists from the central tendency (e.g. a measure of population variance sigma² can be used, from which sigma is calculated). Using the n-sigma rule, a pair is indicated as an outlier if its distance from μ is more than (n)×(sigma).

The real challenge in utilizing this technique is the determination of a robust estimate of the quantities μ and sigma. In the current invention, the Median and Median Absolute Deviation (MAD) have been used to estimate μ and sigma correspondingly. However, any method of determining variation or dispersion from a central tendency can be utilized. For example, a mean can be used instead of or in additional to a median for the central tendency and any measure of variance (biased, unbiased, etc.) may be applicable.

The Median is the numerical value separating the higher half of a data set from the lower half. To calculate the Median of a data set, first the data of the set are sorted and then, if the cardinality is odd the middle value of the sorted data is selected as the median value. If the cardinality of the data set is even then the mean of the two middle values is selected as the median value.

Median Absolute Deviation is defined as the median value of a set containing the absolute deviation of samples from the data's median, and can, for example, be computed using the following relation:

MAD=median({|MVᵢ−median{MV}|}) (2)

Consequently, in order to determine whether a point is an outlier or not, a measure z₁ is formed for each motion vector MVᵢ as follows:

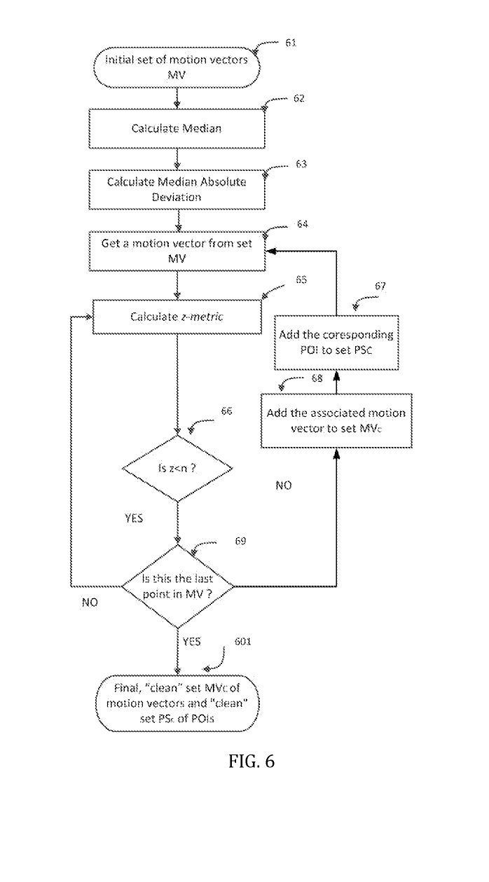

zᵢ=0.647(MVᵢ−μ)/MAD (3)

where μ is the median value of the motion vector set MV. If zᵢ is larger than a predetermined value n, then the motion vector Xᵢ is considered an outlier. Each outlier is then removed from the motion vector set, so at the end of this procedure the motion vector set is “cleared” of any outliers. The associated flow chart of this procedure is shown in FIG. 6.

The selection of parameter n controls the sensitivity of the outlier rejection unit. That is, higher values of n lead to less sensitive outlier rejection in the sense that in order for a motion vector to be considered as an outlier it must be significantly different from the median value and thus significantly different from the general population of the motion vectors comprising the set MV. Small values of n can lead to the false characterization of a motion vector as an outlier, while large values of n can cause one to miss an outlier and thus allow contamination of the data set. In one preferred embodiment and in accordance with the literature (e.g. [ref 1]) a value of 3.5 leads to performance with acceptable robustness.

More analytically, the system implements the following exemplary steps:

The initial set MV of motion vectors (61 in FIG. 6), is input in to the unit from the Local Motion Vector Data memory (23 in FIG. 2). Then the Median value (62 in FIG. 6), and the Median Absolute Deviation value (63 in FIG. 6), are calculated using equation 2. After that for each vector in set MV, the z metric is calculated (65 in FIG. 6) according to equation 3. The system then checks if for some motion vector MVᵢ, zᵢ is smaller than n, (66 in FIG. 6) and if so MVᵢ, is not considered as an outlier and is added to set MV_{c} (68 in FIG. 6) while the corresponding POI is added to the set PS_{C}. After this procedure has been completed for every motion vector in MV, the “cleared” sets MV_{C} and set PS_{C} are output (601 in FIG. 6) to the Cleared Local Motion Vector Data memory (24 in FIG. 2). Note that since some motion vectors may be categorized as outliers, the cardinality N_{PC} of the output sets MV_{C} and PS_{C}, will be less than or equal to the cardinality of the initial sets MV and PS, that is N_{PC}≦N_{P}.

It is noted that in the event that certain POIs are determined to carry a greater weight than others, the estimates of central tendency and variation can be modified to take this into account in the above methods using known techniques.

Global Motion Estimation Unit (226 in FIG. 2)

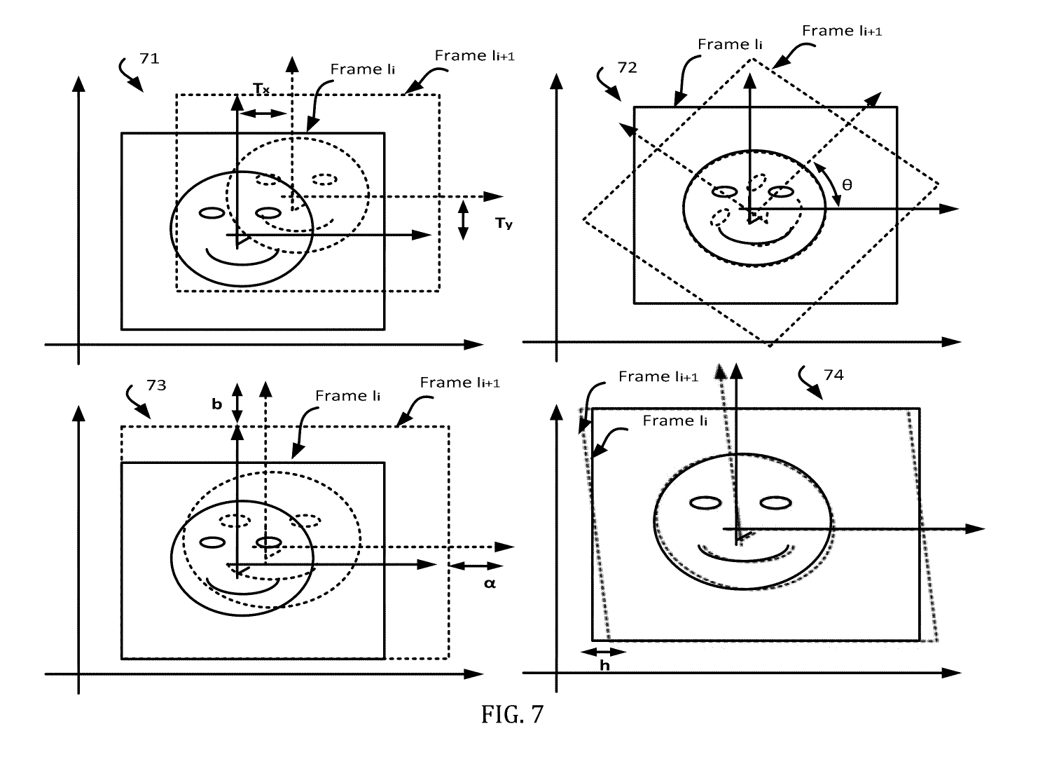

One aim of the Global Motion Estimation unit is to analyze optical flow as represented by the “cleared” (i.e. outlier-free) local motion vectors from cleared motion vector data memory (24 in FIG. 2), in order to obtain the motion of the camera. The full motion of a camera in the 3-D space can be characterized by a total of eight parameters, known as the Degrees of Freedom (DoF). These are two translational components, a rotational component), two scale components, two shearing and a non-linearity component of the shearing. However, in one approach the motion of the camera is estimated using the six most dominant parameters. That is, two Translational components (Tₓ, T_{y}, 71 in FIG. 7), a Rotational component (θ, 72 in FIG. 7), two scale components (α in x-dimension and b in y-dimension, 73 in FIG. 7) and a shearing component (h, 74 in FIG. 7).

The motion of the camera can be modeled by using the concept of the geometrical transformation of images (or equivalently in video-frames). Geometrical transformations are in reality transformations of the Cartesian coordinates of the pixels that images are comprised of. The mathematical equation that describes a geometrical transformation with the six DoF referred above is the following:

$$\begin{matrix}[ \begin{matrix}{x\_out}_{i} \\ {y\_out}_{i}\end{matrix} ] = [ \begin{matrix}1 & h \\ 0 & 1\end{matrix} ] [ \begin{matrix}a & 0 \\ 0 & b\end{matrix} ] [ \begin{matrix}cos θ & - sin θ \\ sin θ & cos θ\end{matrix} ] [ \begin{matrix}{x\_in}_{i} \\ {y\_in}_{i}\end{matrix} ] + [ \begin{matrix}{T}_{x} \\ {T}_{y}\end{matrix} ] \\ or & ( 4 ) \\ [ \begin{matrix}{x\_out}_{i} \\ {y\_out}_{i}\end{matrix} ] = [ \begin{matrix}a cos θ + hb sin θ & - a sin θ + hb cos θ & {T}_{x} \\ b sin θ & b cos θ & {T}_{y}\end{matrix} ] [ \begin{matrix}{x\_in}_{i} \\ {y\_in}_{i} \\ 1\end{matrix} ] & ( 5 )\end{matrix}$$

where x_inᵢ, y_inᵢ are pixel coordinates in the initial image and x_outᵢ, y_outᵢ are the corresponding pixel coordinates in the transformed image.

The transformation of the coordinates can be seen as a movement of pixels and the movement of pixels is estimated at the output of Local Estimation unit (224 in FIG. 2), so there is an obvious relationship between the two units.

Since the POIs always coincide with pixel coordinates, they also undertake the same geometrical transformation with the image pixels. Therefore in the preferred embodiment, the initial coordinates Pᵢ=(x_inᵢ, y_inᵢ) correspond to the initial POI set PS and the final coordinates P_outᵢ=(x_outᵢ, y_outᵢ) correspond to the transformation of the initial POI set. In the event that content-related POIs (e.g. that identify the corners, edges or lines, etc. in an image) are also used, these must be identified in terms of pixel coordinates and used in the subsequent steps.

The transformed set PS_{OUT}={P_out₁, P_out₂, . . . , P_out_{N}} of POIs, can also be expressed as a linear combination of the initial POI set PS plus the local motion vector set MV, that is:

$${P\_out}_{i} = {P}_{i} + {MV}_{i} or [ \begin{matrix}{x\_out}_{i} \\ {y\_out}_{i}\end{matrix} ] = [ \begin{matrix}{x\_in}_{i} \\ {y\_in}_{i}\end{matrix} ] + [ \begin{matrix}Δ {x}_{i} \\ Δ {y}_{i}\end{matrix} ] , \\ ∀ {P}_{i} ∈ {PS}_{C} and {MV}_{i} ∈ {MV}_{C} \qquad ( 6 )$$

In the absence of noise and assuming that there is no error in the local motion estimation process, equations (5) and (6) are describing using the same transformation. Therefore the following relation holds:

$$[ \begin{matrix}{x\_in}_{i} \\ {y\_in}_{i}\end{matrix} ] + [ \begin{matrix}Δ {x}_{i} \\ Δ {y}_{i}\end{matrix} ] = [ \begin{matrix}a cos θ + hb sin θ & - asin θ + hb cos θ & {T}_{x} \\ b sin θ & b cos θ & {T}_{y}\end{matrix} ] [ \begin{matrix}{x\_in}_{i} \\ {y\_in}_{i} \\ 1\end{matrix} ] \qquad ( 7 )$$

Since six parameters need to be estimated, a set of six equations is formed. Since equation (7) breaks into two equations, this equation is used three times for three pairs (P, P_out) of points. In the absence of noise and assuming that there is no error in the local motion estimation process any three (P, P_out) pairs are appropriate to be used. One approach makes available a number of N_{P} points, where N_{PC}>>3 and therefore, since there are more potential equations than unknowns, it is known as an “overdetermined” system. However as referred above, the calculated motion vectors contain estimation errors which manifest themselves as estimation noise. The Outlier Rejection unit (224 in FIG. 2) is used for the coarse elimination of errors, but the remaining motion vectors will also exhibit fluctuations, significant enough to cause errors to the global motion estimation. Therefore the global motion estimation unit must be designed to be as robust as possible in the presence of these kinds of errors.

The presence of errors roughly means that a random choice of three point pairs will probably not be accurate. In certain embodiments, a method is performed that will make use of the entire set of motion vectors in order to produce more robust results.

In one exemplary embodiment, a Least Mean Squares (LMS) approach is used. The LMS method is a standard approach to the approximate solution of overdetermined systems, however any method of solving an overdetermined set of equations may be used. “Least mean squares” means that the overall solution minimizes the sum of the squares of the errors made in the results of every single triplet of equations as described above.

It can be proved mathematically that solving the problem with LMS method is equivalent to solving the following set of equations:

$$\begin{matrix}\overline{D} = {( {\overline{A}}^{t} \cdot \overline{A} )}^{- 1} \cdot {\overline{A}}^{t} \cdot \overline{b} \\ where & ( 8 ) \\ \overline{D} = [ \begin{matrix}{D}_{0} \\ {D}_{1} \\ {D}_{2} \\ {D}_{3} \\ {D}_{4} \\ {D}_{5}\end{matrix} ] = [ \begin{matrix}a cos θ + hb sin θ \\ - a sin θ + hb cos θ \\ b sin θ \\ b cos θ \\ {T}_{x} \\ {T}_{y}\end{matrix} ] , \overline{X} = [ \begin{matrix}{x\_in}_{1} \\ {x\_in}_{2} \\ {x\_in}_{3} \\ ⋮ \\ {x\_in}_{{NP}_{C}}\end{matrix} ] , \\ \overline{Y} = [ \begin{matrix}{y\_in}_{1} \\ {y\_in}_{2} \\ {y\_in}_{3} \\ ⋮ \\ {y\_in}_{N}\end{matrix} ] , \overline{1} = [ \begin{matrix}1 \\ 1 \\ 1 \\ ⋮ \\ 1\end{matrix} ] , \overline{0} = [ \begin{matrix}0 \\ 0 \\ 0 \\ ⋮ \\ 0\end{matrix} ] & ( 9 ) \\ \overline{A} = [ \begin{matrix}\overline{X} & \overline{Y} & \overline{0} & \overline{0} & \overline{1} & \overline{0} \\ \overline{0} & \overline{0} & \overline{X} & \overline{Y} & \overline{0} & \overline{1}\end{matrix} ] \\ and & ( 10 ) \\ \begin{matrix}\overline{b} = [ \begin{matrix}{x\_out}_{1} & {y\_out}_{1} \\ {x\_out}_{2} & {y\_out}_{2} \\ {x\_out}_{3} & {y\_out}_{3} \\ ⋮ & ⋮ \\ {x\_out}_{{NP}_{C}} & {y\_out}_{{NP}_{C}}\end{matrix} ] \\ = [ \begin{matrix}{x\_in}_{1} & {y\_in}_{1} \\ {x\_in}_{2} & {y\_in}_{2} \\ {x\_in}_{3} & {y\_in}_{3} \\ ⋮ & ⋮ \\ {x\_in}_{{NP}_{C}} & {y\_in}_{{NP}_{C}}\end{matrix} ] + [ \begin{matrix}Δ {x}_{1} & Δ {y}_{1} \\ Δ {x}_{2} & Δ {y}_{1} \\ Δ {x}_{3} & Δ {y}_{3} \\ ⋮ & ⋮ \\ Δ {x}_{{NP}_{C}} & Δ {y}_{{NP}_{C}}\end{matrix} ]\end{matrix} & ( 11 )\end{matrix}$$

From the elements of matrix D̅ which is the solution of (8), the wanted motion parameters can be obtained as follows:

$$θ = atan ( \frac{{D}_{2}}{{D}_{1}} ) , b = {D}_{2} / sin θ , \\ h = ( {D}_{0} + {D}_{1} {D}_{3} / {D}_{2} ) / ( {D}_{2} + {D}_{3} {D}_{3} / {D}_{2} ) , \\ a = ( {D}_{0} - hb sin θ ) / cos θ , {T}_{x} = {D}_{4} , {T}_{y} = {D}_{5} \qquad ( 12 )$$

In (8), the only unknown quantity is the inverse of the 6×6 matrix (Ā^{t}·Ā). This inversion can be carried out in many ways. In the preferred embodiment an analytical method using determinants to avoid recursive arithmetic solutions that may exhibit instabilities. However, any matrix inversion method may be used at this step of the method.

Once the matrix inversion is determined, one is able to solve (8) to find the matrix D, and using the elements of this matrix, the global motion parameter set PAR={Tₓ, T_{y}, θ, α, b, h} can be determined through (12), which are then outputted to the Global Motion Data memory (25 in FIG. 2).

Down-sampling Unit (222 in FIG. 2)

In the down-sampling unit, the image is down-sampled by a number k, where k>1. In the down-sampling of an image frame I of size H by V, to an image frame J of size [(1/k)·H] by [(1/k)·V] (k>1), each pixel J (x, y) has a value described by the following relation:

$$J ( x , y ) = \frac{{\sum }_{i = 0}^{k - 1} {\sum }_{j = 0}^{k - 1} I ( kx + i , ky + j )}{{k}^{2}} \qquad ( 13 )$$

In this case the final image frame is k² times smaller (as a number of pixels) than the initial image frame.

Coarse Fine Arbitration unit (223 in FIG. 2)

The aim of the Coarse Fine Arbitration unit is to control the estimation process in order to operate on either down-sampled images (coarse estimation) or on original images (fine estimation).

The Full Search algorithm (as described in the Local Motion Estimation Unit section above), while producing very accurate results, is very demanding in terms of computational resources, especially in the case of intense camera motion. In this case the pixel displacements are large and thus the search_radius parameter must be also large in order to be able to catch these large displacements.

The complexity ◯ of the block search algorithm that the LME unit (224 in FIG. 2) implements, expressed as a number of operations, is given by the following relation.

0N_{P}×(block_size)²(2×search_radius+1)² (14)

From (14) it is apparent that ◯ is proportional to the square of the double of search_radius parameter. Therefore increasing the value of the search_radius parameter is not a good idea, since it will dramatically increase the complexity of the algorithm and thus the computer operations needed to carryout the task. This fact causes a significant amount of increase to the power consumption (higher number of operations means higher power consumption) and decrease to the throughput of the system (higher number of operations means lower throughput).

To this end in a case like this a different approach should be followed, employing down-sampling of the image.

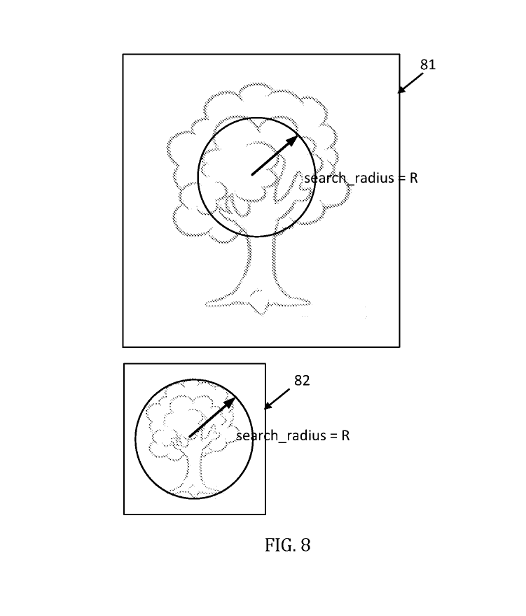

As it is indicated in FIG. 8 in the down-sampled by k=2 image J (82), a circle with search_radius=R covers a larger area of the image, when compared to the area that the same circle covers in the original image (81). Therefore the effective search radius is k times larger while the quantity ◯ remains the same as shown in equation (14). However since the resolution of the down-sampled image is now, for example, k² times smaller, there will be fewer available details in the image for the LME unit to follow and therefore the resolution of the estimated motion will be now much lower.

To overcome this problem, a coarse-fine calculation procedure is performed as follows in the Coarse Fine Arbitration unit (223 in FIG. 2).

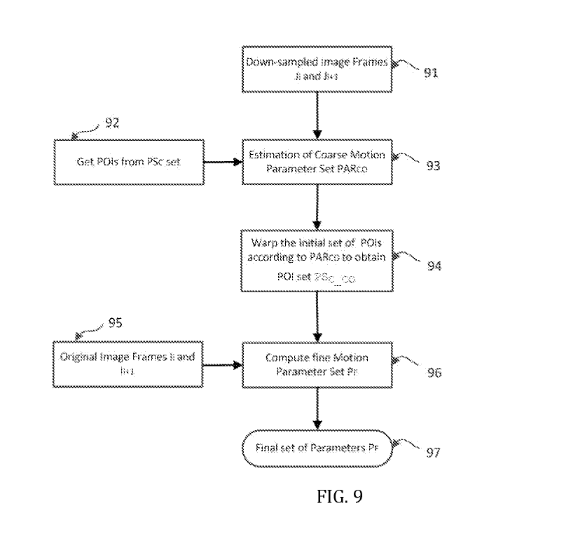

As shown in the flow chart in FIG. 9, the unit functions as follows: First the Motion Estimation is performed on the down-sampled frames Jᵢ and Jᵢ₊₁ (91 in FIG. 9) using POIs from PS_{C} set (92 in FIG. 9). As a result, an initial coarse motion estimation is performed and the coarse motion parameters set PAR_{CO}={Tₓ_{_{—}}_{CO}, T_{y}_{_{—}}_{CO}, θ_{CO}, α_{CO}, b_{CO}, h_{CO}} is obtained FIG. 9). Then, these parameters are used to warp the initial set PS_{C} of POIs, to a new set PS_{C}_{_{—}}_{CO} using the transform (5) (94 in FIG. 9). The new, warped POI set PS_{C}_{_{—}}_{CO} is now incorporating the coarse computation of the parameter set PAR_{CO}. After this, the Motion Estimation is repeated on the original frames Iᵢ and Iᵢ₊₁ (95 in FIG. 9), using POIs from PS_{C}_{_{—}}_{CO}, in order to perform the fine computation of the parameter set P_{F} (96 in FIG. 9).

The systems, methods and techniques described herein performed or implemented on any device that comprises at least one camera, including but not limited to, standalone cameras, security cameras, smart cameras, industrial cameras, mobile phones, tablet computers, laptop computers smart TV sets and car boxes, i.e. a device embedded or installed in an automobile that collects video and images. It will be understood and is appreciated by persons skilled in the art, that one or more processes, sub-processes or process steps described in embodiments of the present invention can be implemented in hardware and/or software.

While the above-described flowcharts and methods have been discussed in relation to a particular sequence of events, it should be appreciated that changes to this sequence can occur without materially effecting the operation of the invention. Additionally, the exemplary techniques illustrated herein are not limited to the specifically illustrated embodiments but can also be utilized and combined with the other exemplary embodiments and each described feature is individually and separately claimable.

Additionally, the systems, methods and protocols of this invention can be implemented on a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. In general, any device capable of implementing (or configurable to implement) a state machine that is in turn capable of implementing (or configurable to implement) the methodology illustrated herein can be used to implement the various methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein can be readily implemented in hardware and/or software using any known or later developed systems or structures, devices and/or software by those of ordinary skill in the applicable art from the functional description provided herein and with a general basic knowledge of the audio processing arts.

Moreover, the disclosed methods may be readily implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated system or system component, or the like. The system can also be implemented by physically incorporating the system and/or method into a software and/or hardware system, such as the hardware and software systems of an electronic device.

It is therefore apparent that there has been provided, in accordance with the present invention, systems and methods for reducing reverberation in electronic devices. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

### REFERENCES

Ref 1: Boris Iglewicz and David Hoaglin (1993), “Volume 16: How to Detect and Handle Outliers”, The ASQC Basic References in Quality Control: Statistical Techniques, Edward F. Mykytka, Ph.D., Editor.—Incorporated herein by reference in its entirety.

1. A method of estimating motion of a device comprising:
storing at least two consecutive frames of an image in at least one memory location on the device,
downsampling to eliminate at least one pixel in said image frames;
selecting at least one point of interest in a first of said image frames,
calculating a first set of estimates of motion from the at least one point of interest;
removing at least one outlier from said first set of estimates of motion to create a second set of estimates of motion;
wherein the second set of estimates of motion is smaller in number than the first set of estimates of motion; and
determining a global motion estimate from said second set of estimates of motion.

2. The method of claim 1, further comprising:
calculating a median value of a set of motion vectors,
calculating a median absolute deviation value from said set of motion vectors,
calculating a measure for at least one motion vector that is related to said median value and said median absolute deviation value, and
characterizing a motion vector as an outlier if said measure is larger than a predetermined value.

3. The method of claim 1, wherein the at least one point of interest is chosen based on a predetermined location within an image frame that is independent of a characteristic relating to the value of the pixels in said image frame.

4. The method of claim 1, wherein the device is a standalone camera, a security camera, a smart camera, an industrial camera, a mobile phone, a tablet computer, a laptop computer, a smart TV set or a car box.

5. A device capable of:
storing at least two consecutive frames of an image in at least one memory location on the device,
downsampling to eliminate at least one pixel in said image frames;
selecting at least one point of interest in a first of said image frames,
calculating a first set of estimates of motion from the at least one point of interest;
removing at least one outlier from said first set of estimates of motion to create a second set of estimates of motion;
wherein the second set of estimates of motion is smaller in number than the first set of estimates of motion; and
determining a global motion estimate from said second set of estimates of motion.

6. The device of claim 5, further comprising:
calculating a median value of a set of motion vectors,
calculating a median absolute deviation value from said set of motion vectors,
calculating a measure for at least one motion vector that is related to said median value and said median absolute deviation value, and
characterizing a motion vector as an outlier if said measure is larger than a predetermined value.

7. The device of claim 5, wherein the at least one point of interest is chosen based on a predetermined location within an image frame that is independent of a characteristic relating to the value of the pixels in said image frame.

8. The device of claim 5, wherein the at least one memory location is on a standalone camera, a security camera, a smart camera, an industrial camera, a mobile phone, a tablet computer, a laptop computer, a smart TV set or a car box.

9. A non-transitory computer-readable information storage media having stored thereon instructions, that if executed by a processor, cause to be performed a method comprising:
storing at least two consecutive frames of an image in at least one memory location,
downsampling to eliminate at least one pixel in said image frames;
selecting at least one point of interest in a first of said image frames,
calculating a first set of estimates of motion from the at least one point of interest;
removing at least one outlier from said first set of estimates of motion to create a second set of estimates of motion;
wherein the second set of estimates of motion is smaller in number than the first set of estimates of motion; and
determining a global motion estimate from said second set of estimates of motion.

10. The media of claim 9, further comprising:
calculating a median value of a set of motion vectors,
calculating a median absolute deviation value from said set of motion vectors,
calculating a measure for at least one motion vector that is related to said median value and said median absolute deviation value, and
characterizing a motion vector as an outlier if said measure is larger than a predetermined value.

11. The media of claim 9, wherein the at least one memory location is on a standalone camera, a security camera, a smart camera, an industrial camera, a mobile phone, a tablet computer, a laptop computer, a smart TV set or a car box.
